(19) United States
(12) Patent Application Publication
(10) Pub. No.: US 2006/0098701 A1
(43) Pub. Date: May 11, 2006

(54) Optical transmitter

(75) Inventor: Shigeo Hayashi, Kanagawa (JP)

Correspondence Address: VENABLE LLP, P.O. BOX 34385, WASHINGTON, DC, 20045-9998, US

(73) Assignee: Sumitomo Electric Industries, Ltd., Osaka (JP)

(21) Appl. No.: 11/254,742

(22) Filed: Oct. 21, 2005

(30) Foreign Application Priority Data
Oct. 26, 2004 (JP) 2004-311395

(51) Int. Cl. H01S 3/00

(52) U.S. Cl. 372/38.02

(57) ABSTRACT

The present invention provides an optical transmitter that includes a configuration and a circuit capable of operating in a high frequency. The optical transmitter of the invention provides a supplemental circuit within the package, which includes a transistor, typically an n-type FET, with the drain connecting to the anode of the light-emitting device and the voltage source outside of the package and the gate thereof connecting to the output of the driver provided outside of the package and also to the cathode of the light-emitting device, and the source of the FET is grounded.

### BACKGROUND OF THE INVENTION

1. Field of the Invention

The present invention relates to an optical transmitter including a light-emitting device, which constitutes an optical transceiver applied in the optical communication. In particular, the invention relates to a circuit provided within the transmitter that enables to drive the light-emitting device in high speed and in stable.

2. Related Prior Arts

An optical transceiver generally includes an optical transmitter and an optical receiver that installs a light-emitting device and a light-receiving device, respectively, built with an electronic circuit in the housing. To operate the light-emitting device in the optical transmitter is necessary, as disclosed in Japanese patent published as H05-007144, for a driver, an auto-temperature controlling (ATC) circuit, and an auto-power controlling (APC) circuit. Various types of the driver circuit have been well known. The driver is roughly categorized into two types, namely, the current driving circuit and the voltage driving circuit.

Japanese patent published as H05-007144 has disclosed a driver for the laser diode (LD), in which two transistors complementary to each other and are driven with the signals common to each other, are connected in series and the LD is connected in parallel to one of transistors. Although this driver may operate in a high speed, a pnp-transistor capable of operating in the high speed is hard to be available.

Another Japanese patent published as 2001-015854 has disclosed another driver circuit in which the LD is connected in series to the driver transistor, especially, in a low-powered application. In this configuration, since the LD is connected in series to the signal transistor, the transition from the OFF state to the ON state, namely, the transistor turning from OFF to ON, is hard to vary in a high speed.

Still another Japanese patent published as 2001-320121 has disclosed a driver circuit in which the LD is connected in the anode thereof to the emitter of the transistor. In this configuration, it is possible to transit from the OFF state to the ON state because the transistor turns on to flow the emitter current to the LD. On the other hand, the transition from the ON state to the OFF state is delayed because the transistor connected in series to the LD turns off prior to the transition of the LD, which is hard to extract carries from the LD and inevitably delays the transition. Moreover, the configuration disclosed is inferior to control the magnitude of the current because the LD is connected in direct and series to the emitter of the transistor.

From a viewpoint of the stableness of the operation and the controllability of the current, the driver is preferable in the configuration that the LD is connected in series to the collector of the transistor, or in the configuration of the voltage driving circuit. However, the cutoff frequency of the transistor, or the operating speed of the voltage driver determines the operable frequency of the LD. Although the contrivance in the assembly of the LD and the driver, or the integration of the LD with the driving circuit may improve the operable frequency, the cost in the material and the productivity may increase. For example, when the driver is installed within the package, not only the count of the lead pins includes but also the additional heat derived from the driver is generated within the package, which requests the special package in the lead pin and the unique design in the heat dissipation efficiency.

The optical transmitter according to the present invention, carried out to solve the above subjects, has features to be applicable in the optical transceiver and stably operable in the high speed.

### SUMMARY OF THE INVENTION

An optical transmitter of the invention comprises a light-emitting device and a supplemental circuit. The light-emitting device may be typically a laser diode. The supplementary circuit, which may be an n-type field effect transistor (n-FET), a p-type FET, an npn-type bipolar transistor, or a pnp-type bipolar transistor, includes a control electrode and two current electrodes. The control electrode controls the current flowing between two current electrodes. The supplemental circuit of the present invention has a feature that the light-emitting device is connected between the control electrode and one of current electrodes of the transistor.

Thus configured supplemental circuit, by receiving the driving signal in the control electrode of the transistor, may operate in the light-emitting device and the transistor in complement. That is, when the driving signal turns off the transistor by applying a logically low level in the control electrode thereof, the same driving signal turns on the light emitting device by pulling down one of the electrode thereof. On the other hand, the driving signal turns on the transistor by applying a logically high level to the control electrode thereof, the same driving signal may pull up one of the electrode connected to the control electrode of the transistor, which turns off the light-emitting device. Thus, the configuration of the present invention may accelerate the switching from the low to high levels and from the high to low levels, which enables the optical transmitter to operate in a high speed.

The optical transmitter may further comprise a package in which the light-emitting device and the supplemental circuit are enclosed. Moreover, the optical transmitter may further provide a driver for outputting the driving signal to the supplemental circuit outside of the housing. Even in such configuration of the optical transmitter that the driver is placed outside of the package, the supplemental circuit with the transistor within the package, the switching of the light-emitting device from the logically high to low levels, or from the logically low to high levels, may not disturbed.

The optical transmitter may further comprise a resistor or an inductor connected to one of the current electrodes of the transistor and to one of the electrodes of the light-emitting device within the package, and the bias is applied from a voltage source placed outside of the package via the resistor or the inductor. Even in this configuration, the light-emitting device and the transistor may operate in complementary to each other; the high speed switching may be maintained.

### BRIEF DESCRIPTION OF DRAWINGS

FIG. 1 is a block diagram of the optical transmitter that includes an n-type FET according to the present invention;

FIG. 2A is a side view and FIG. 2B is a plan view of the optical transmitter of the invention; and

FIG. 3 is a circuit diagram included in the optical transmitter shown in FIG. 2A and FIG. 2B.

Next, preferred embodiments according to the present invention will be described as referring to accompanying drawings. In drawings and specifications, same elements will be referred by the same symbols or numerals without overlapping explanations.

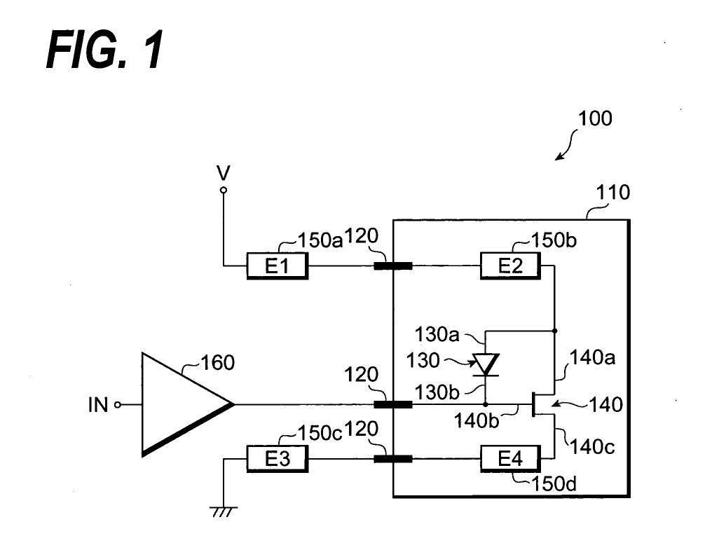

FIG. 1 is a block diagram of the optical transmitter according to the present invention. The optical transmitter 100 shown in FIG. 1A comprises a light-emitting device 130, a package 110 enclosing the light-emitting device 130, a driver 160 provided outside of the package 110, a supplemental circuit for compensating the driver 160, which is enclosed within the package 110 and includes an n-type FET 140.

The drain 140a of the n-type FET 140 connects not only to the anode 130a of the light-emitting device but also to the voltage source outside of the package 110 via the lead pin 120. The 140b of the n-type FET 140 connects not only to the driver 160 via the lead pin 120 but also to the cathode 130b of the light-emitting device 130. The source 140c of the n-type FET 140 is grounded via the lead ping 120.

The drain 140a of the n-type FET 140, as shown in FIG. 1A, may be connected to the voltage source via the lead pin 120. In an alternative, the drain 140a may be connected to the voltage source via a device 150a (E1) provided outside of the package 110 and another device 105b (E2) within the package 110. In this case, the devices E1 and E2 may be a combination of a resistor R and an inductor L as shown in the following table I. In the table I, the symbol “-” denotes that the device is short-circuited.

TABLE I
Combination of element E1 and E2

| E1 | E2 |
|---|---|
| — | — |
| — | resistor |
| — | inductor |
| — | resistor and inductor |
| | connected in series |
| resistor | — |
| resistor | inductor |
| inductor | — |
| inductor | resistor |
| resistor and inductor | — |
| connected in series | |

Although the source 140c of the FET 140 is grounded via the lead pin 120, as shown in FIG. 1A, it may be grounded via a device 150c (E3) outside of the package 110 and another device 150d (E4) within the package 110. The devices E3 and E4 may be configured by a resistor R and an inductor L as shown in the following table II. Also in the table II, the symbol “-” denotes the device is short-circuited.

TABLE II
Combination of element E3 and E4

| E3 | E4 |
|---|---|
| — | — |
| — | resistor |
| — | inductor |
| — | resistor and inductor |
| | connected in series |
| resistor | — |
| resistor | inductor |
| inductor | — |
| inductor | resistor |
| resistor and inductor | — |
| connected in series | |

The driver 160 provided outside of the package 110 may be a current-driving circuit and a voltage-driving circuit. The output power of the voltage source and the output levels, high and low levels, of the driver 160 depend on the extinction ratio of the output optical signal requested to the present optical transmitter 100. The supplemental circuit thus configured, combined with the conventional driver 160, enables to drive the light-emitting device with superior speed.

The embodiment above explained concentrates on the n-type FET for the supplemental circuit, the n-FET may be replaced by a p-type FET, an npn-bipolar transistor or a pnp-bipolar transistor.

Next will explain an operation of the supplemental circuit shown in FIG. 1A. The description below refers to a voltage driving circuit for the driver, and the devices E1, E3 and E4 are short-circuited, while the device E2 is a resistor R for the explanation sake. The voltage source outputs a DC voltage of 2 (V), the resistance of the resistor E2 is 16 (Ω), and the input levels, which corresponds to the output levels V_{O} of the driver 160, are Low=0 (V) and High=0.8 (V), respectively. The n-type FET 140 flows the drain current of 0 (mA) for Vgs =0 (V) and 20 (mA) for Vgs=0.8 (V), respectively. The light-emitting device 130 shows a performance that the forward current I_{LD} and the forward voltage Vf are 5 (mA) and 0.8 (V) for the logical low level and 50 (mA) and 1.2 (V) for the logical high level, respectively.

When the output level of the driver 160 is V_{O}=0 (V), the FET 140 becomes turned off and no current flows. In this case, since the light-emitting device 130 is biased in forward, the current from the voltage source flows in the light-emitting device 130 via the resistor E2, which is provided within the package, and sinks into the driver 160. The drain voltage of the FET and the forward current of the light-emitting device become Vd=1.2 (V) and I_{LD}=50 (mA), respectively. While, the output level of the driver 160 is V_{O}=0.8 (V), which turns on the FET 140, the drain current becomes I_{FET}=20 (mA). In this case, the voltage drop at the resistor R becomes 16 (Ω)*20 (mA)=0.32 (V). Practically, the light-emitting device 130 flows some current therein, the slightly larger voltage drop may occur at the resistor R. The forward voltage Vf of the light-emitting device 130 becomes 2−0.32−0.8=0.88 (V). That is, the forward current of the light-emitting device becomes I_{LD}=5 (mA), which corresponds to the logical low level of the light-emitting device 130. In the optical transmitter shown in FIG. 1A, by modulating the output of the driver 160 between 0 (V) and 0.8 (V), the forward current I_{LD} flowing in the light-emitting device 130 may be varied between 5 (mA) and 50 (mA). The most important point in the optical transmitter 100, the output level of the driver 160 only swings from 0 (V) to 0.8 (V). While, the conventional transmitter without supplemental circuit within the package, the swing voltage is necessary from 0.8 (V) to 1.2 (V) to obtain the same modulation performance for the light-emitting device with the present invention.

When the resistance E2 within the package 110 is short-circuited, it is necessary to drive the light-emitting device 130 directly. The equivalent impedance of the light-emitting device is rather small, which becomes hard to drive in direct. Moreover, the lead pin 120 provided in the package accompanies a parasitic inductance of around 1 (nH) which causes a parasitic impedance of 19 (Ω) at 3 (GHz). Accordingly, even no resistance E2 is connected in series to the light-emitting device 130 and the FET 140, the parasitic impedance of the lead pin 120 must be taken into account.

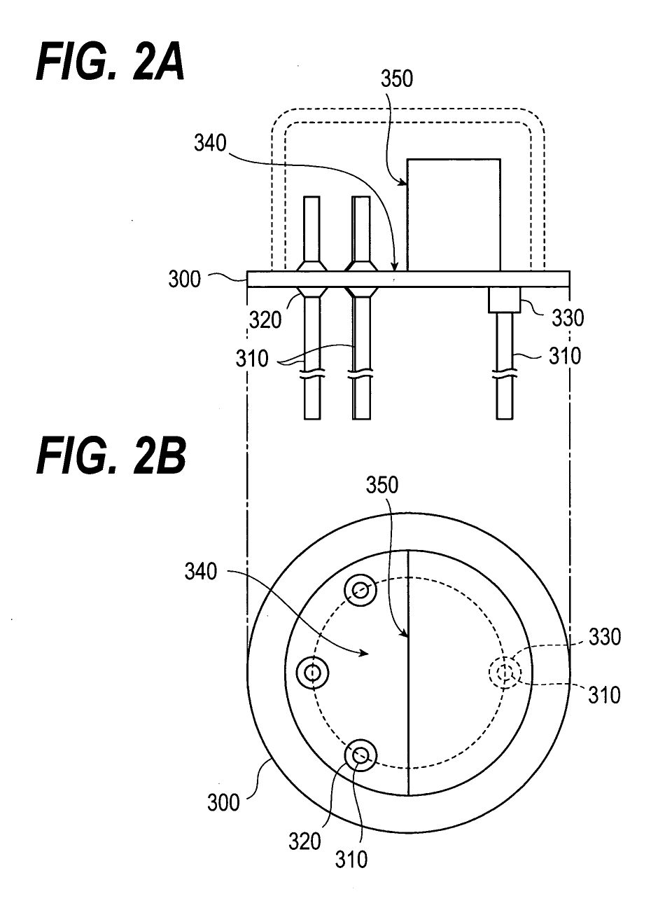

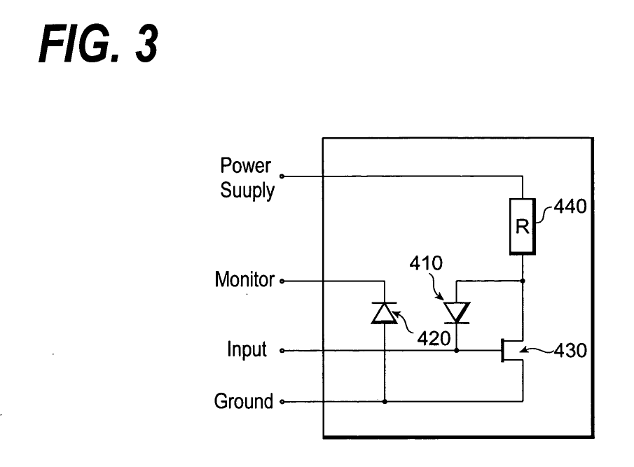

FIG. 2A is a side view and FIG. 2B is a plan view of the optical transmitter described above. The optical transmitter shown in these drawings provides a stem 300, which is made of Kovar coated with nickel (Ni) and gold (Au) and installs a circuit shown in FIG. 3 that includes the supplemental circuit according to the present invention on the surfaces 340 and 350. The stem 300 includes a plurality of holes for securing the lead pin 310 as electrically isolating therefrom. That is, the lead pin 310, which is also coated with nickel (Ni) and gold (Au), is fixed within the hole as a glass sealant filling the gap between the stem. Moreover, a ground lead 310 is directly fixed to the stem with the metallic member 330.

Thus, the optical transmitter shown in FIG. 2 provides four lead pins 310. However, the ground may be floated from the package. That is, the ground lead in FIG. 2, which is connected to the FET and the PD within in the package and directly fixed to the package with the metallic member, may be isolated from the package and another lead pin directly connected to the package may be provided. The circuit shown in FIG. 3 includes a photodiode (PD) 420 that monitors the output optical level of the light-emitting device, which is typically a laser diode (LD) 410. The cathode of the PD 420 is led to the outside of the package, while the anode thereof is grounded. In an alternative, the anode of the PD is connected to the voltage source via the lead pin, or may be led to the outside of the package via an independent lead pin.

The laser diode 420 is mounted on the side surface 350 of the stem 300, while the PD 420 is mounted on the plane surface 340. The resistor 440 and the FET 430 are mounted on the side surface 350. Between devices and between the lead pin 310 and the device are connected with bonding-wires made of gold with a diameter of about 25 μm. The length of the lead pin extending from the outer surface of the step 300 originally has about 9 mm for the productivity of this transmitter. However, in the practical configuration, namely, when the transmitter is built in an optical transceiver, the lead pin 310 is cut to left 1 to 5 mm, which shows the parasitic inductance of 2 to 5 (nH) and may not be disregarded.

The conventional configuration of the driver circuit is necessary for the devices used therein to show the operable speed greater by several decades of percentages than the transmission speed.

The laser diode 410 in the transmitter is necessary to show the operable speed greater than the transmission speed by several decades of percentages, while the electron device in the supplemental circuit, the FET, has the cutoff frequency ft exceeding several decades of giga-hertz. Moreover, the parasitic capacitance accompanied with the FET is far smaller than that of the LD. For example, the junction capacitance of the LD applied in the 2.5 Gbps transmission speed reaches 20 to 30 (pF), while that of the FET is only 100 to 200 (fF), three digits smaller than that of the LD. Therefore, the present invention, which drives the cathode of the LD with the signal applied to the control electrode of the electron device, the FET, is so effective to operate the LD with a high frequency signal.

What is claimed is:

1. An optical transmitter, comprising:
a light-emitting device for emitting light; and
a supplemental circuit including a transistor having two current electrodes and a control electrode for controlling a current flowing between the current electrodes,
wherein the light-emitting device is connected between the control electrode and one of the current electrodes of the transistor.

2. The optical transmitter according to claim 1,
wherein the one of the current electrodes, the light emitting device being connected thereto, is connected to a voltage source via a resistor.

3. The optical transmitter according to claim 1,
wherein the one of the current electrodes, the light emitting device being connected thereto, is connected to a voltage source via an inductor.

4. The optical transmitter according to claim 1,
further provides a driver for outputting a driving signal to the control electrode of the transistor.

5. The optical transmitter according to claim 4,
further comprises a package for installing the light-emitting device and the supplemental circuit therein,
wherein the driver is placed outside of the package.

6. The optical transmitter according to claim 4,
wherein the one of the current electrodes connected to the light-emitting device is connected to a voltage source via a resistor, and
wherein the voltage source is placed outside of the package and the resistor is placed within the package.

7. The optical transmitter according to claim 4,
wherein the one of the current electrodes connected to the light-emitting device is connected to a voltage source via an inductor, and
wherein the voltage source is placed outside of the package and the inductor is placed within the package.

8. The optical transmitter according to claim 1,
wherein the light-emitting device is a laser diode.

9. The optical transmitter according to claim 1,
wherein the transistor is an n-type field effect transistor, two current electrodes being a drain and a source, respectively, and the control electrode being a gate thereof.
